(19) United States
(12) Patent Application Publication
(10) Pub. No.: US 2010/0005700 A1
(43) Pub. Date: Jan. 14, 2010

(54) ROBOTIC FISHING LURE

(76) Inventor: Kenneth Dale Thomas, Kalaheo, HI (US)

Correspondence Address: DONALD W. MEEKER, 924 EAST OCEAN FRONT, # E, NEWPORT BEACH, CA, 92661, US

(21) Appl. No.: 12/562,914

(22) Filed: Sep. 18, 2009

Related U.S. Application Data
(63) Continuation-in-part of application No. 12/171,917, filed on Jul. 11, 2008, now abandoned.

(51) Int. Cl. A01K 85/01; A01K 85/00

(52) U.S. Cl. 43/17.1; 43/26.2; 43/42.09; 43/42.22

(57) ABSTRACT

A remote radio controlled robotic fishing lure device replicates bait animals in size, shape, movement and sound. A remote control signals a radio receiver inside the lure to activate a simple magnetic actuator to activate simulated bait animal extremity movement and/or sound.

### CROSS-REFERENCE TO RELATED APPLICATIONS

The present application is a continuation-in-part of utility patent application Ser. No. 12/171,917 filed Jul. 11, 2008.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to a fishing lure and in particular to a remote radio controlled robotic fishing lure device replicating bait animals in size, shape, movement and sound, which utilizes a simple magnetic actuator remotely controlled to activate simulated bait animal extremity movement on demand and a remotely controlled programmable microchip and subminiature speaker for bait animal sound generation on demand.

2. Description of Related Art including information disclosed under 37 CFR 1.97 and 1.98

In order to be highly effective in catching fish, such as bass, it is necessary to replicate the bait animals, fish, and insects that they prefer for food as closely as possible including shape, motion, and sound.

The prior art remote controlled fishing lures all focus in one way or another on using a cell phone type vibrator motor for vibration only and have no legs or tail that are remote controlled and do not reproduce bait animal sounds. They are often expensive to make and do not rely on simple mechanical operation.

Related prior art patents and published patent applications include U.S. Pat. No. 6,684,556, B1, US20050257418A1, US20040200125A1, U.S. Pat. No. 6,920,714, U.S. Pat. No. 7,055,280, U.S. Pat. No. 6,836,995, U.S. Pat. No. 6,804,909, U.S. Pat. No. 6,789,347, U.S. Pat. No. 6,910,294, US20020014031A1, U.S. Pat. No. 6,449,895, U.S. Pat. No. 6,581,319, U.S. Pat. No. 6,035,574, U.S. Pat. No. 5,894,692, U.S. Pat. No. 5,535,538, U.S. Pat. No. 5,321,905, U.S. Pat. No. 5,105,573, U.S. Pat. No. 4,922,647, U.S. Pat. No. 4,380,132, U.S. Pat. No. 3,841,012, U.S. Pat. No. 7,207,135, U.S. Pat. No. 7,080,476, US20050150151A1, U.S. Pat. No. 6,880,287, US20030115788A1, U.S. Pat. No. 6,779,291, US20030154642A1, US20020104250A1, US20020088165A1, U.S. Pat. No. 6,192,617, U.S. Pat. No. 5,172,510, U.S. Pat. No. 4,980,987, U.S. Pat. No. 4,884,359, U.S. Pat. No. 4,858,370, U.S. Pat. No. 4,700,501, U.S. Pat. No. 4,676,020, U.S. Pat. No. 4,581,841, U.S. Pat. No. 4,594,806, U.S. Pat. No. 4,468,879, U.S. Pat. No. 4,177,597, U.S. Pat. No. 4,133,135, U.S. Pat. No. 3,465,464, U.S. Pat. No. 3,457,667.

What is needed is a remote radio controlled robotic fishing lure device replicating bait animals in size, shape, movement and sounds, which utilizes a simple magnetic actuator and programmable sound device remotely controlled to activate simulated bait animal extremity movement and sounds.

### BRIEF SUMMARY OF THE INVENTION

An object of the present invention is to provide a remote radio controlled robotic fishing lure device replicating bait animals in size, shape, movement and sounds, which utilizes a simple magnetic actuator and programmable sound device remotely controlled to activate simulated bait animal extremity movement and sounds.

In brief, a unique feature of the present invention is the mechanical manner in which the legs and/or tail is caused to move and a remotely controlled sound producing feature. The lure body is to be made of injection molded hard plastic in two parts (top and bottom) with locater protrusions so that the body can be glued and snapped together. Once the soft rubber legs and/or tail are attached, the lure is completely water tight. As the lure is designed to be used in fresh water, this will not pose a problem with battery discharge.

Another unique feature of the present invention is the baby alligator shape. There are no lures on the market with this shape. This hollow body lure replicates a baby alligator with soft rubber extremities and may be made without any electronics at all. The most unique feature of this embodiment is the lures ability to move the legs and tail.

There are three types of lures using the radio control:

1—e-Bassfrog which has legs that will kick
2—e-Basspop which has legs that will kick
3—e-Bassgator which has both legs that will kick and a tail which swings side to side.

In addition to the movement the lures make, they may have an extra channel on the receiver with an implanted microchip which will, on demand, cause each lure to make a pre-recorded actual bait animal sound. The frog will make a frog “ribbit” sound, the pop will make a “cricket” sound and the gator will make a baby alligator “hatchling squeaking” sound. The lure e-Basspop is named for a common bass fishing lure called a “popper” which makes a popping sound when its moved.

The components for reproducing the actual sound of the bait animal are encapsulated in a housing which is inserted in the simulated bait animal body. The housing is placed within a hollow soft rubber body of whichever shape you choose; frog, gator, popper or other. The lure body can therefore be changed very easily if and when it gets damaged. The insert reproduces the pre-recorded actual sound of the bait animal.

The appendages may be removable so that a fisherman can change the legs when they get ripped without having to change the lure body and he can change the legs to the type and color he wishes as conditions change.

The housing is preferably encapsulated in a material that makes it buoyant, so the lures float.

An advantage of the present invention is that it provides a simple magnetically activated mechanical robotic remote control fishing lure which simulates the appearance, movements and sounds of fishing bait animals.

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is a sectional side view of a first embodiment of the invention, illustrating a remote radio controlled artificial fishing lure with legs, to create a fishing lure in a shape that emulates a frog, baby alligator, mouse, rat, aquatic insect, or other chosen shape;

FIG. 2 is a bottom view of the first embodiment of the invention illustrating the various components of the fishing lure;

FIG. 3 is perspective top view of a second embodiment device illustrated as an alligator wherein both front legs, both back legs, and the tail can move either independently or in any combination;

FIG. 4 is a top sectioned view of the second embodiment device;

FIG. 5 is a side sectioned view of the second embodiment device;

FIG. 6 is a top sectioned view of a third embodiment device;

FIG. 7 is a top plan view of the remote control of the present invention;

FIG. 8 is a sectional side view of the remote control of FIG. 7;

FIG. 9 is a side sectioned view of a basspop body having the radio receiver, batteries, and magnetic actuator with an actuator arm in the body interior;

FIG. 10 is a side sectioned view of a basspop body having alternate positioning of the radio receiver, batteries, and magnetic actuator with an actuator arm in the body interior;

FIG. 11 is a top sectioned view of a basspop body having the radio receiver, batteries, and magnetic actuator with an actuator arm in the body interior and showing the external legs;

FIG. 12 is perspective top view of another embodiment device of the present invention illustrated as a baby frog or tadpole with tail-like streamers showing the internal power source, receiver, and sound transmitter;

FIG. 13 is perspective top view of another embodiment device of the present invention illustrated as a baby frog with wagging feet showing the internal power source, receiver, and sound transmitter;

FIG. 14 is perspective top view of another embodiment device of the present invention illustrated as a rounded rectangular body with trailing hook showing the internal power source, receiver, and sound transmitter;

FIG. 15 is perspective top view of another embodiment device of the present invention illustrated as a large insect with tail-like streamers showing the internal power source, receiver, and sound transmitter.

### DETAILED DESCRIPTION OF THE INVENTION

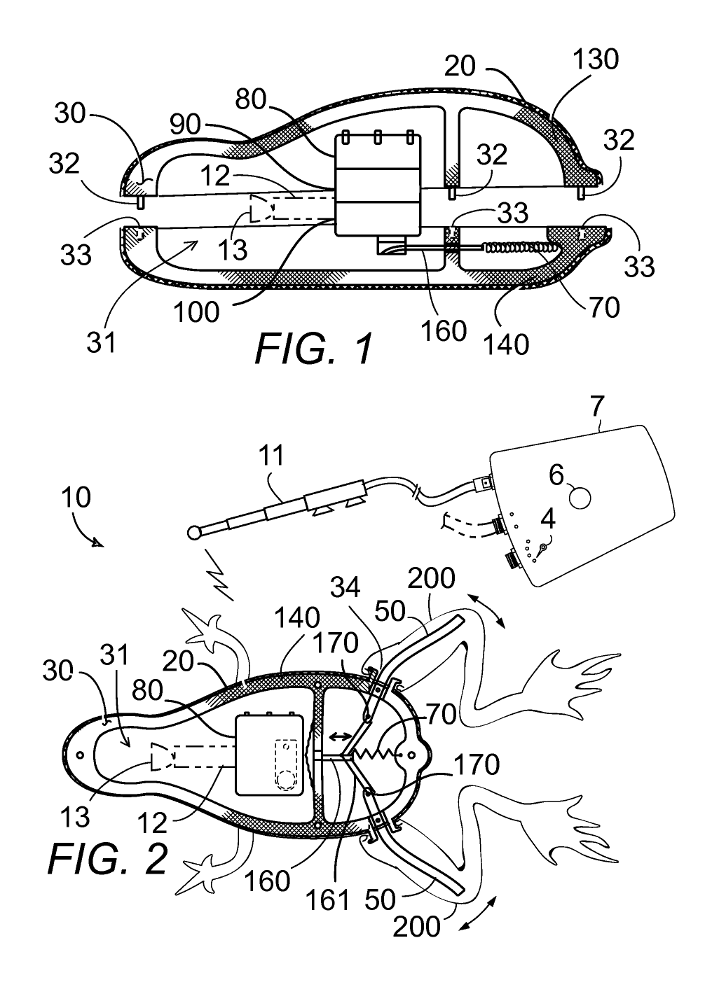

In FIGS. 1-15, a remote radio controlled robotic fishing lure device 10 replicates bait animals in size, shape, movement and sound.

In FIG. 1, a watertight simulated body 30 of a simulated fishing bait creature, a frog in this embodiment, comprises a hard inner upper shell 130 snapped together to a hard inner lower shell 140 each with a rubberized outer covering 20 simulating the outer skin of the bait creature. Pins 32 in one half snap fit into mating holes 33 in the other half. A watertight inner space 31 houses at least one radio receiver 90 and at least one magnetic actuator 100 for creating motion positioned therein. The radio receiver 90 communicates with the magnetic actuator 100. The simulated body 30 has a number of openings 34 around the perimeter for receiving extremities 50 attached thereto in a watertight fit.

The magnetic actuator 100 and 210 may comprise a rare earth magnet actuator or a servo mechanism imparting motion to the control arm.

The power source preferably comprises a rechargeable battery 80 within the lure body having battery charger connections extending outside of the lure body in the fishing line attachment ring and hook attachment ring so that the lure does not have to be taken apart or any inside access necessary at all in order to charge the battery.

The flexible simulated extremities 50 of the fishing bait creature each comprise a soft rubberized replica of an extremity 50 of the fishing bait creature, in this case a frog leg, which fits with a tight watertight fit in one of the openings 34 in the body of the fishing bait creature to plug the opening so that the body is sealed watertight. The magnetic actuator 100 is attached to each of the extremities 50 by means for linking the at least one magnetic actuator to each of the extremities to enable the at least one magnetic actuator 100 to create movement simulating the natural movement of each extremity in the fishing bait creature.

In FIGS. 1 and 2, a control arm 160 is attached to the magnetic actuator 100 and optional extension control arms 161 connecting to extremity moving arms 50 which extend from inside the simulated body into an extremity 200. Each extremity moving arm 50 is pivotally attached to the control arm wherein the magnetic actuator imparts a back and forth motion (shown by internal arrow) to the control arm 160 and the control arm imparts a movement to the extremity moving arm to create the simulated extremity movement (shown by external arrows). The control arm 160 is further attached to a spring 70 attached to the body to draw the control arm 160 toward the back after the magnetic actuator 100 drawings the control arm 160 forward to create the back and forth motion to move the extremities.

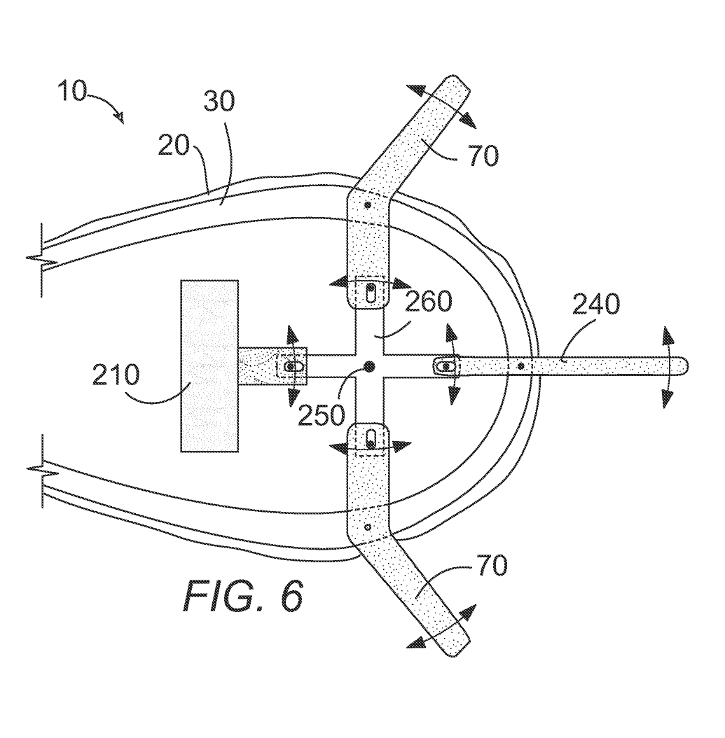

In FIG. 6, the control arm 260 pivotally attached to the actuator 210 has a plurality of extension control arms which each connect to an extremity moving arm such as leg extremity moving arms 70 and tail extremity moving arm 240 activate an extremity moving arm. The control arm 260 is further attached to a control arm pivot mechanism 250 in the center of the control arm connected to an interior surface of the simulated body.

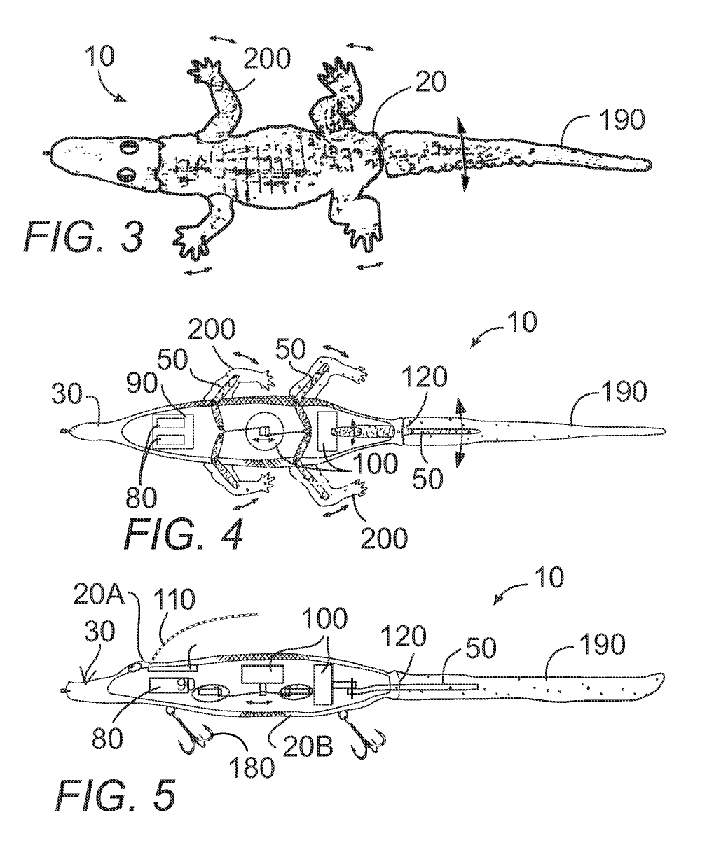

In FIGS. 1-6, the lure body comprises a molded body in the shape of a bait creature taken from the list of bait creatures comprising a frog in FIGS. 1 and 2, a baby alligator in FIGS. 3-5, a fish, and an aquatic insect.

In FIGS. 1 and 2, the molded body 30 is in the shape of a frog and the extremities 200 comprise simulated frog legs that simulate a kicking motion natural to frog legs so that the extremities simulate a natural swimming motion of a frog in water.

In FIGS. 1-5, the simulated body 30 is in the shape of a baby alligator and the extremities comprise simulated baby alligator legs 200 that simulate a kicking motion natural to baby alligator legs and a simulated baby alligator tail 190 that simulates a natural side to side swinging movement (arrows) of a baby alligator tail so that the extremities simulate a natural swimming motion of a baby alligator in water.

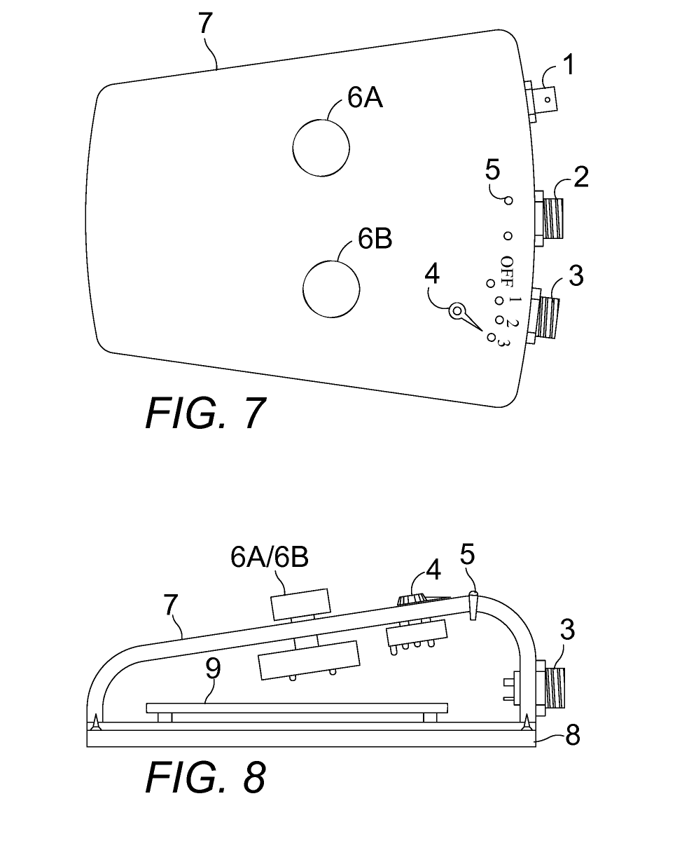

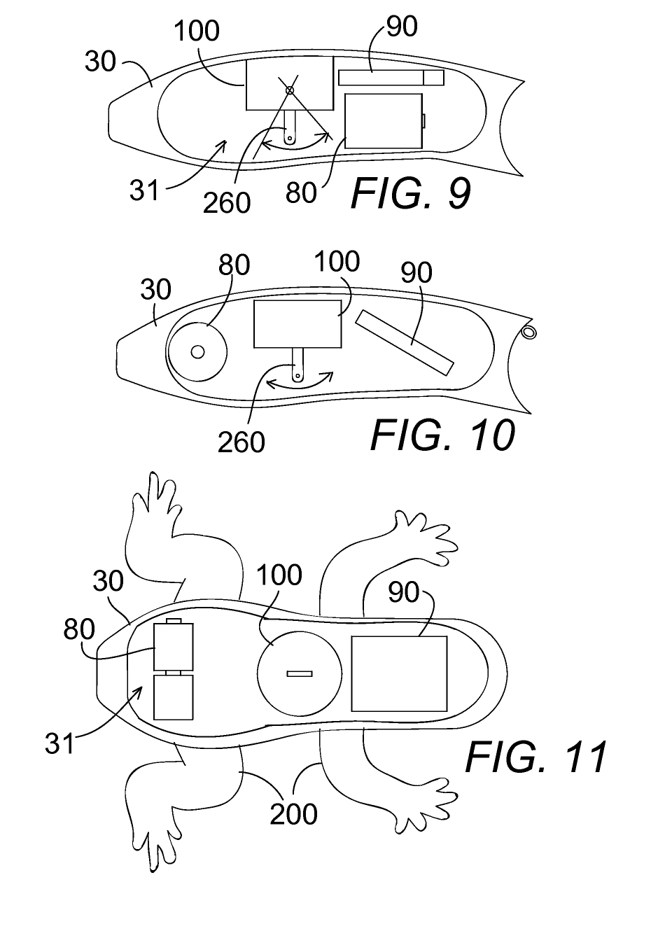

In FIGS. 9-11, the simulated body 30 with interior space 31 is in the shape of a basspop and the extremities comprise simulated basspop legs 200 that simulate a kicking motion activated by a control arm 160 attached to a magnetic actuator 100 powered by a battery or batteries 80 and receiving signals through a radio receiver 90 from the remote control (7 as in FIGS. 7 and 8) held by the fisherman.

A sound generating microchip 12 and subminiature speaker 13 for bait animal sound generation on demand are installed within the watertight simulated body 30, the microchip 12 communicating with the radio receiver so that the radio transmitter 9 sends a separate signal activated by a second foot button 6B on the remote control to the radio receiver 90 causing the radio receiver to activate the sound generating microchip 12 to make a pre-recorded sound through the subminiature speaker 13 of a natural recorded sound of the fishing bait creature. The microchip 12 generates a pre-recorded sound depending upon the nature of the fishing bait creature simulated body housing the microchip, the pre-recorded sound is of a live bait animal sound taken in a natural environment and taken from the list of simulated sounds including a frog ribbit sound, a basspop cricket sound, and a baby alligator hatchling squeaking sound.

In FIGS. 7 and 8, a hand and foot operated remote control 7 housing a radio control transmitter 9, the remote control alternately held by a user in a first position for hand control with a hand control switch 4 for turning the magnetic actuator 100 on and off and setting the choice of which robotic lure is being used, and alternately positioned near a foot of a user in a second position for foot control using a first foot actuated button 6A for controlling motion in the robotic lure and a second foot actuated button 6B for controlling sound in the robotic lure while a user holds a fishing rod, the radio control transmitter controlling the robotic fishing lure device for fishing, the radio control transmitter wirelessly communicates with the radio receiver 90 in the simulated body which activates the magnetic actuator 100 to create movement in each of the extremities 50 simulating the natural movement of each extremity in the fishing bait creature. A mating hook and loop fastener patch 8 on the bottom of the remote control allows it to be removable attached to the carpeting on a fishing boat or other convenient location. An antenna is removably attachable to the BNC antenna connector 1 on the remote control. A power source is connectable to the two conductor male power connector 2 on the remote control. The remote control is connectable to a power charge source via a two conductor female charge connector 3 on the remote control. An antenna 11 transmits the radio signals from the remote control to the receiver 90.

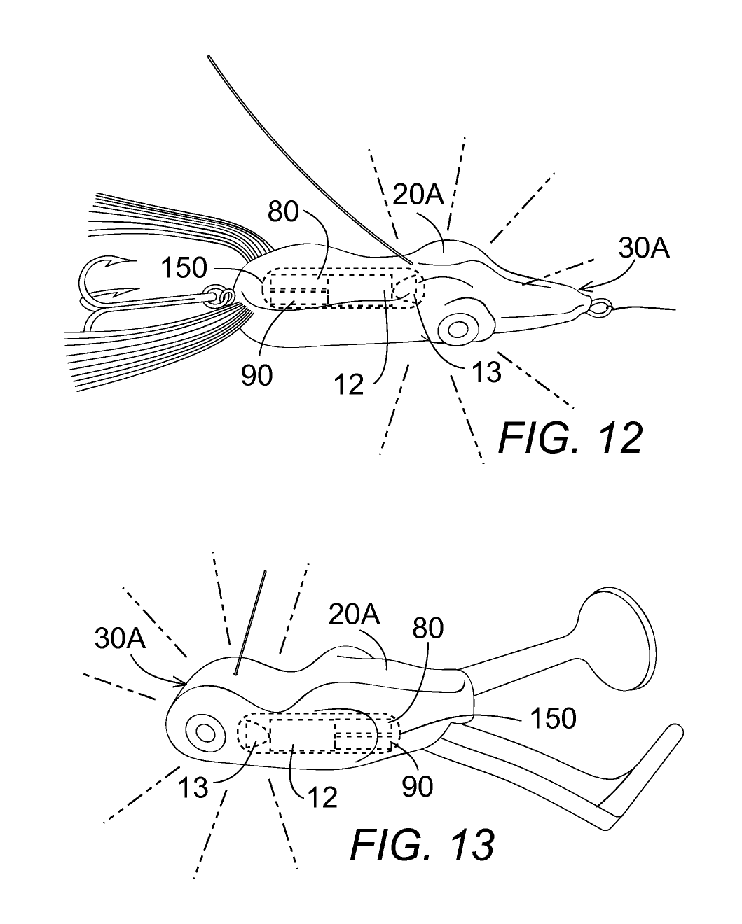

In FIGS. 12-15, an alternate watertight simulated body 30A of a simulated fishing bait creature or a similarly sized body, which may be a rubberized body and has a rubberized outer covering 20 simulating the outer skin of the bait creature and each provides a moving outer appendage element which moves as the body is dragged through the water and an internal sound generating housing 150 inserted in the body. The sound generating housing 150 encloses a sound generating microchip 12 and subminiature speaker 13 for bait animal sound generation on demand installed within the watertight simulated body 30. The microchip 12 communicates with the radio receiver 90 so that the radio transmitter 9 sends a separate signal activated by a second foot button 6B on the remote control to the radio receiver 90 causing the radio receiver to activate the sound generating microchip 12 to make a pre-recorded sound through the subminiature speaker 13 of a natural recorded sound of the fishing bait creature. The sound generating housing 150 may be fabricated of buoyant material so that the simulated body 30A floats with the sound generating housing inserted therein. The sound generating housing 150 may be removed and replaced.

In FIG. 12, the watertight simulated body 30A simulates a baby frog or tadpole with tail-like streamers showing the sound generating housing 150 having an internal power source 80, radio receiver 90, sound generating microchip 12 and sound transmitter, such as a subminiature speaker 13.

In FIG. 13, the watertight simulated body 30A simulates a baby frog with wagging feet showing the sound generating housing 150 having an internal power source 80, radio receiver 90, sound generating microchip 12 and sound transmitter, such as a subminiature speaker 13.

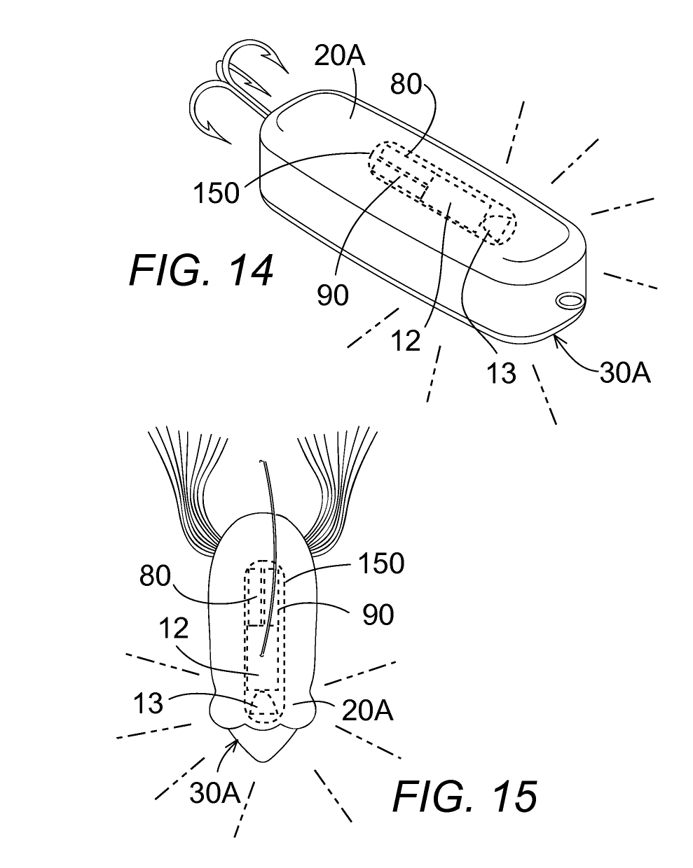

In FIG. 14, the watertight simulated body 30A as a rounded rectangular body simulates the size of a fishing bait creature with trailing hook wagging behind, showing the sound generating housing 150 having an internal power source 80, radio receiver 90, sound generating microchip 12 and sound transmitter, such as a subminiature speaker 13.

In FIG. 15, the watertight simulated body 30A as a rounded rectangular body simulates a large insect with tail-like streamers showing the sound generating housing 150 having an internal power source 80, radio receiver 90, sound generating microchip 12 and sound transmitter, such as a subminiature speaker 13.

In use, the watertight simulated body 30 and 30A of a fishing bait creature is attached to a fishing line and cast into the water. The remote control 7 is turned on and adjusted to the desired choice of robotic lure being used with the manual control 4. The remote control may be placed on the ground fishing boat carpet or attached to a bait box on the ground and operated by a foot of a user on the foot control buttons 6A and 6B while the fisherman holds the fishing rod and reel with two hands. The bottom hooks 180 hook a fish attacking the lure.

It is understood that the preceding description is given merely by way of illustration and not in limitation of the invention and that various modifications may be made thereto without departing from the spirit of the invention as claimed.

### INDEX

### Reference Numbers of the Parts of the Invention Shown in the Drawings

1 is a BNC antenna connector on the remote control.
2 is a two conductor male power connector on the remote control.
3 is a two conductor female charge connector on the remote control.
4 is the remote control on/off channel select switch for the type of robotic lure in use.
5 is the remote control green LED “active” indicator.
6A is the remote control foot switch for motion.
6B is the remote control foot switch for sound.
7 is the high impact plastic housing of the remote control device operable by a hand or a foot of a user.
8 is a hook and loop fastener adhered to the bottom of the remote control.
9 is the transmitter for the remote control.
10 is a remote radio controlled robotic artificial fishing lure device that provides motion.
20 is a soft rubber outer skin or stand alone form. This outer skin can take the shape of a frog, baby alligator, mouse, rat, aquatic insect or other desired forms.
30 is a watertight simulated body.
30A is an alternate watertight simulated body.
50 is an actuator arm.
70 is a spring.
80 is a battery.
90 is a radio control model receiver.
100 is a servo or a rare-earth magnet actuator.
110 is an antenna.
120 is a tail pivot point.
130 is a top half of lure body.
140 is a bottom half of lure body.
150 is a housing for the sound producing element
160 is a stainless steel wire.
170 is a leg attachment point.
180 is a fish hook.
190 is a silicon rubber tail.
200 is a silicon rubber leg.
210 is a magnetic actuator.
240 is a tail attach point.
250 is a main pivot point.
260 is a main control arm.

What is claimed is:

1. A remote radio controlled robotic fishing lure device simulating bait animals, the device comprising:
a watertight simulated body of a fishing bait creature comprising an outer shell having a watertight inner space housing, at least one radio receiver and at least one sound simulation actuator, the at least one radio receiver communicating with the at least one sound simulation actuator for generating a sound of a live bait creature;
at least one movable appendage attached to the simulated body with a watertight fit;
a hand and foot operated remote control housing a radio control transmitter, the remote control alternately held by a user in a first position for hand control and alternately positioned near a foot of a user in a second position for foot control while a user holds a fishing rod, the radio control transmitter controlling the robotic fishing lure device for fishing, the radio control transmitter wirelessly communicating with the at least one radio receiver in the body which activates the at least one sound simulation actuator to causing the lure to emit a pre-recorded replica of an actual live bait animal on demand.

2. The device of claim 1 further comprising a power source, wherein the at least one radio receiver and at the least one sound simulation actuator and the power source are housed together in a waterproof housing removable inserted in the simulated body so that the waterproof housing may be removed and inserted in a different simulated body.

3. The device of claim 2 wherein the waterproof housing is fabricated of a buoyant material so the simulated body floats with the buoyant waterproof housing inserted therein.

4. The device of claim 1 wherein the at least one movable appendage comprises a flexible simulated extremity removably attached to the watertight simulated body so that the simulated extremity is removable and replaceable.

5. The device of claim 1 wherein the simulated body has at least one opening through the outer shell and the at least one movable appendage comprises at least one simulated animal bait extremity which fits with a tight watertight fit in one of the at least one openings to plug the opening so that the body is sealed watertight and further comprising at least one magnetic actuator for creating motion positioned within the simulated body in communication with the at least one radio receiver, the at least one magnetic actuator attached to each extremity by means for linking the at least one magnetic actuator to each extremity to enable the at least one magnetic actuator to create movement simulating the natural movement of each extremity.

6. The device of claim 5 further comprising a control arm attached to the magnetic actuator and at least one extremity moving arm extending from inside the simulated body into each extremity, each extremity pivotally attached to the control arm wherein the magnetic actuator imparts a back and forth motion to the control arm and the control arm imparts a movement to the extremity moving arm to create the simulated extremity movement.

7. The device of claim 6 wherein the control arm is further attached to a control arm pivot mechanism connected to an interior surface of the simulated body and the control arm comprises at least one extension control arm portion extending outwardly from the control arm pivot mechanism to connect to the at least one extremity moving arm.

8. The device of claim 7 wherein the control arm has a plurality of extension control arms which each activate an extremity moving arm.

9. The device of claim 5 wherein the magnetic actuator comprises a rare earth magnet actuator imparting motion to at least one control arm.

10. The device of claim 5 wherein the magnetic actuator comprises a servo mechanism imparting motion to at least one control arm.

11. The device of claim 5 further comprising a control wire and spring attached to the magnetic actuator and at least one extremity moving arm extending from inside the simulated body into an extremity, the at least one extremity attached to the control wire wherein the magnetic actuator and spring impart a back and forth motion to the control wire and the control wire imparts a movement to the at least one extremity to create the simulated extremity movement.

12. The device of claim 1 wherein the power source comprises a rechargeable battery within the lure body having battery charger and further comprising means for charging the rechargeable battery within the simulated body.

13. The device of claim 1 wherein the lure body comprises a molded body in a shape of a bait creature taken from a list of bait creatures comprising a frog, a baby alligator, a basspop, a mouse, a rat, a fish, and an aquatic insect.

14. The device of claim 13 wherein the molded body is in a shape of a frog and the extremities comprise simulated frog legs that simulate a kicking motion natural to frog legs so that the extremities simulate a natural swimming motion of a frog in water.

15. The device of claim 13 wherein the molded body is in a shape of a baby alligator and the extremities comprise simulated baby alligator legs that simulate a kicking motion natural to baby alligator legs and a simulated baby alligator tail that simulates a natural side to side swinging movement of a baby alligator tail so that the extremities simulate a natural swimming motion of a baby alligator in water.

16. The device of claim 13 wherein the molded body is in a shape of a basspop and the extremities comprise simulated basspop legs that simulate a kicking motion natural to basspops so that the extremities simulate a natural swimming motion of a basspop in water.

17. The device of claim 1 wherein the at least one sound actuator comprises a remotely controlled programmable microchip and a subminiature speaker for bait animal sound generation on demand installed within the watertight simulated body, the microchip communicating with the at least one radio receiver so that the radio transmitter sending a separate signal activated by a second foot button to the at least one radio receiver causes the at least one radio receiver to activate the sound generating microchip to emit a pre-recorded sound of a live fishing bait creature.

18. The device of claim 17 wherein the microchip generates a pre-recorded sound transmitted through the subminiature speaker depending upon a nature of a fishing bait creature simulated body housing the microchip, the pre-recorded sound being a live bait animal sound taken in a natural environment and taken from a list of simulated sounds including a frog ribbit sound, a basspop cricket sound, and a baby hatchling alligator squeaking sound.
